(19) United States
(12) Patent Application Publication
(10) Pub. No.: US 2024/0401597 A1
(43) Pub. Date: Dec. 5, 2024

(54) Charging system of a fuel cell

(71) Applicant: IHI Charging Systems International GmbH, Amt Wachsenburg OT Ichtershausen (DE)

(72) Inventors: Sasa SLAVIC, Heidelberg (DE); Timm KIENER, Ludwigsburg (DE)

(73) Assignee: IHI Charging Systems International GmbH, Amt Wachsenburg OT Ichtershausen (DE)

(21) Appl. No.: 18/697,996

(22) PCT Filed: Oct. 11, 2022
(86) PCT No.: PCT/DE2022/100751

§ 371 Date: Apr. 2, 2024

(30) Foreign Application Priority Data
Oct. 21, 2021 (DE) 10 2021 127 333.1

(51) Int. Cl. F04D 25/08; F04D 25/06; F04D 29/10; F04D 29/16; H01M 8/04111

(52) U.S. Cl. CPC F04D 25/082; F04D 25/0606; F04D 29/102; F04D 29/162; H01M 8/04111

(57) ABSTRACT

A charging system of a fuel cell includes a housing for receiving a rotatable compression wheel and a rotatable expansion wheel. The housing includes a compression section and an expansion section. The compression section is designed to receive the compression wheel and the expansion section is designed to receive the expansion wheel. An electric motor for driving a shaft is connected at least to the expansion wheel for conjoint rotation therewith. The electric motor is accommodated in a motor housing. In order to cool the electric motor the motor housing is formed with the housing such that a flow can pass therethrough. The expansion wheel for delivering expansion gas, which flows through the expansion wheel, into the motor housing is arranged in the housing. The expansion wheel is arranged between the compression wheel and the motor housing.

### CROSS-REFERENCE TO RELATED APPLICATION

This application is a national stage application, filed under 35 U.S.C. § 371, of International Patent Application PCT/DE2022/100751, filed on Oct. 11, 2022, which claims the benefit of German Patent Application DE 10 2021 127 333.1, filed on Oct. 21, 2021.

### TECHNICAL FIELD

The disclosure relates to a charging system of a fuel cell.

### BACKGROUND

Drive systems of, in particular, motor vehicles are increasingly comprising fuel cells as drive assemblies. Oxygen in the form of atmospheric oxygen is to be supplied to the fuel cell during its operation. A charging system which has already proven successful in supplying air to and increasing the power of an internal combustion engine and which is known, an exhaust gas turbocharger, is suitable for this purpose.

However, by reason of the substantially lower temperatures of an exhaust gas exiting the fuel cell and which in this context is referred to as an expansion gas because it acts upon an expansion wheel of the charging system and does not have a composition according to the typical known exhaust gas, it may be necessary to provide assistance to the charging system which has a rotatably arranged compression wheel and has the likewise rotatably arranged expansion wheel which is connected to the compression wheel for conjoint rotation therewith, said assistance being in the form of an electric motor. The electric motor is then positioned typically between the compression wheel and the expansion wheel or, in other words, between a compression section of the charging system and an expansion section of the charging system.

### SUMMARY

The present disclosure provides a charging system of a fuel cell which has a cost-effective design.

The disclosure relates to a charging system of a fuel cell, comprising a housing for receiving a rotatable compression wheel and a rotatable expansion wheel, wherein the housing comprises a compression section and an expansion section, wherein the compression section is designed to receive the compression wheel and the expansion section is designed to receive the expansion wheel. An electric motor is configured to drive a shaft which is connected at least to the expansion wheel for conjoint rotation therewith, wherein the electric motor is accommodated in a motor housing. In order to cool the electric motor the motor housing is formed with the housing such that a flow can pass therethrough, wherein the expansion wheel for delivering expansion gas, which flows through the expansion wheel, into the motor housing is arranged in the housing, and wherein the expansion wheel is arranged between the compression wheel and the motor housing. Therefore, it is possible in a simple and cost-effective manner to achieve preferential cooling in the form of air cooling of the electric motor which heats up during operation. Air cooling is particularly advantageous, since sealing the electric motor and housing against water ingress, which is required in the case of water cooling, is complex and therefore cost-intensive.

In this case, it is possible to envisage two different embodiments, wherein one of the two embodiments is characterised by the fact that air drawn in by the compression wheel is guided into the compression section via the motor housing, and so cool fresh air from the environment flows into the motor housing and is compressed in the compression section after leaving the motor housing and supplied to the fuel cell. For this purpose, the compression wheel for drawing in the air via the motor housing is arranged in the housing in such a manner that it is accommodated in its simplest arrangement between the expansion section and the motor housing, so that a direct inflow from the motor housing into the compression section can be achieved.

Provision is made that the expansion wheel for delivering expansion gas, which flows through the expansion wheel, into the motor housing is arranged in the housing. For this purpose, the expansion wheel is preferably arranged between the compression wheel and the motor housing so that the expansion gas can flow off directly into the motor housing.

The two embodiments differ in terms of a flow direction of the air cooling. If the air is intended for cooling with the aid of the compression wheel, it flows from the environment via the motor housing into the compression section. However, if the expansion gas is used for cooling the motor housing, it flows out of the expansion section into the motor housing and from this location into the environment.

The compression wheel and the expansion wheel are advantageously designed in the form of a single-piece system wheel which has a shaft. The advantage of the charging system can be seen in the fact that with the aid of the single-piece design of the compression wheel and of the expansion wheel a charging system can be provided which is substantially smaller in its axial extent than has hitherto been known. Furthermore, components of the charging system, such as e.g. the shaft or the housing, can be produced at reduced cost. A further advantage can be seen in the fact that a possible leakage of hydrogen or lubricant with the expansion gas can be directed away from the charging system. Lubricant can thus also be prevented from penetrating into the fuel cell.

The system wheel can be produced from two different materials, i.e. in other words the compression wheel is produced from the first material and the expansion wheel is produced from a second material which is different from the first material. This involves a typically cost-intensive joining method. However, since the temperatures of the gases, the compression gas and the expansion gas are not temperatures as are known from internal combustion engine construction and the exhaust gas temperatures thereof, the expansion wheel is produced in a cost-effective manner from a second material which corresponds to the first material. That is to say in other words that the system wheel is produced from one single material which, however, can also be a composite material and/or an alloy or the like.

In a further embodiment of charging system, the compression section and the expansion section are designed to effect wall heat exchange of compression gases flowing in the compression section and expansion gases flowing in the expansion section. That is to say in other words that the two sections, through which their respective gas flows, are designed such that the expansion gas can cool the compression gas and the compression gas can heat the expansion gas. It is easily possible in this manner to dispense with a so-called charging air cooler, a cooler for reducing a temperature of the compression gas after compression thereof, or said cooler can be reduced at least in terms of its dimensioning.

For this purpose, the expansion section is advantageously designed at least partially surrounding the compression section. Wall heat exchange can easily be achieved in this manner because between the expansion gas and the compression gas only a wall is formed, via which the heat of the gases can be channelled.

In a further embodiment of the charging system, the expansion section is arranged at least partially axially next to the compression section. This arrangement is provided preferably in the region of the system wheel which has the compression wheel and the expansion wheel virtually wheel back to wheel back, thus arranged axially next to one another, so that the compression wheel can be advanced into its compression channel and the expansion wheel can be supplied from its expansion channel.

In an advantageous manner, the electric motor is surrounded by a motor housing which is designed to mount the shaft. That is to say in other words that a rotatable mounting arrangement of the shaft can be effected with the aid of the motor housing. Therefore, it is easily possible to achieve secure mounting of the shaft because, irrespective of a design of the mounting arrangement, the mounting arrangement can be spaced apart from the system wheel and thus spaced apart from the expansion gas and can be protected therefrom at least to the greatest possible extent.

In a further embodiment of the charging system, the motor housing is designed at least partially as a single piece with the housing. In particular, the motor housing is formed as a single piece with at least a part of the expansion section, thus making it possible to achieve cost-effective production and/or preferential air cooling of the electric motor.

In a further embodiment of the charging system, the shaft is a built-up shaft. That is to say in other words that the shaft is formed from at least two parts which are joined together. They can be connected together e.g. in an integrally bonded manner and/or in a force-fitting and/or form-fitting manner. The advantage can be seen in the fact that, in dependence upon a design of the electric motor, a stator or a rotor of the electric motor can be received in a section of the shaft.

Preferably, the shaft is designed to receive the rotor of the electric motor and is connected thereto in particular for conjoint rotation therewith. Likewise, a connection to the rotor for conjoint rotation therewith can also be configured depending upon requirement. With the aid of the built-up shaft, the rotor can be easily received in a secure manner in a cavity of the shaft.

In order to avoid a reduction in the performance of the charging system or at least to reduce a loss of performance of the charging system by reason of the single-piece system wheel which requires preferential sealing of the compression section with respect to the expansion section, a housing wall which separates the compression and the expansion section has sealing in the form of a labyrinth seal. Labyrinth seals, also referred to as contact-free shaft seals, are characterised by virtue of the fact that parts which are movable relative to one another have sealing of their spaces remote from the seal.

In particular, the labyrinth seal is formed between the compression wheel and the housing wall, and a gap formed between the compression wheel and the housing wall can be prolonged with the aid of the labyrinth seal, and flow resistance in the gap can be substantially increased. Therefore, fluidic sealing of the compression section and the expansion section is produced.

The shaft is advantageously mounted with the aid of a radial bearing which is a plain bearing or a rolling bearing or an air bearing. It is possible to combine the types of bearing. That is to say in other words that the shaft can be mounted with a radial bearing e.g. in the form of a plain bearing and with a radial bearing e.g. in the form of a rolling bearing. Or a radial bearing pairing can be designed in the form of an air bearing-rolling bearing pairing. Different combinations are feasible.

Furthermore, the shaft advantageously has an axial bearing which is a plain bearing or a rolling bearing or an air bearing. Typically, it is necessary to provide only one axial bearing so that a pairing of different types of bearing is not necessary. However, if more than one axial bearing has to be provided, for instance e.g. if two mutually separate shaft pieces are present, different types of bearings can also be paired in this case.

It is mentioned at this juncture that an axial bearing is redundant when a rolling bearing is used. In order to reduce costs, it is therefore advantageous to effect so-called hybridisation of the types of bearing, in particular to provide an air bearing in the region downstream of the system wheel and to arrange a rolling bearing in the region remote from the system wheel. If sealing means are additionally also provided, then a possible ingress of lubricant into the compression section of the housing with the system wheel, which has the compression wheel and the expansion wheel formed as a single piece, is eliminated or at least reduced to the greatest possible extent.

A further sealing means which is arranged surrounding the shaft and serves to provide sealing between the housing and the motor housing, in particular the electric motor, is arranged on a conical section of the shaft and/or on a conically formed sleeve surrounding the shaft. The further sealing means is preferably designed in the form of a labyrinth seal. The advantage is that the conical design of the section of the shaft or sleeve allows liquids such as lubricant, water or grease to penetrate into the additional sealing means, particularly when the shaft is stationary, i.e. when the shaft is not rotating, or at very low rotational speeds of the shaft. With the aid of the conical design of the shaft and/or the sleeve which is characterised in particular by the fact that a largest cone diameter of the conical design is arranged facing towards the expansion section and a smallest cone diameter of the conical design is arranged facing towards the motor housing, the liquid which has penetrated is delivered in the direction of the expansion wheel and removed from the further seal by reason of the centrifugal force during start-up or when the rotational speed is increasing. The cone diameter can be a shaft diameter of the shaft and/or a sleeve diameter of the sleeve.

Preferably, in order to provide additional sealing the system wheel is designed to be liquid-repellent. That is to say in other words that the system wheel is designed to repel liquids and/or is protected against damage caused by the impact of water droplets. This can be achieved by corresponding shaping of the system wheel or by coating and/or by e.g. hardening the system wheel, in particular the expansion wheel.

In order to repel liquid, a hub surface of the system wheel facing towards the electric motor is designed to be liquid-repellent for this purpose. That is to say in other words that this hub surface can be coated e.g. to be liquid-repellent. Preferably, however, it is designed to be liquid-repellent with the aid of its geometric shape. It could be concave e.g. in the direction of the motor housing. In a preferred embodiment, the hub surface has a projection, in particular on an outer circumference of the hub surface. Therefore, it is possible in a particularly effective manner to move the liquid, which is delivered in the direction of the expansion wheel by reason of the centrifugal force, in the direction of an outlet of the expansion section.

In order to prevent damage to the system wheel caused by water droplets which can impact on the system wheel with a specific impulse and therefore with a specific force, a correspondingly wear-resistant and/or hard coating can be applied to the system wheel, or e.g. the system wheel can be fully or partially hardened. Therefore, it is formed to be liquid-resistant.

It is mentioned at this juncture that, if e.g. the system wheel has the compression wheel arranged between the motor housing and the expansion wheel, the above explanation relating to the repelling of liquid naturally applies to the compression wheel.

In a further embodiment of the charging system, a flow cross-section-changing device is formed upstream of the expansion wheel in the expansion section. This can be designed in the form of a known guide device of an exhaust gas turbocharger, e.g. a so-called VGS, VTG or an axial slide valve.

Further advantages, features and details of the invention will be apparent from the following description of preferred exemplified embodiments and with reference to the drawing. The features and combinations of features mentioned earlier in the description and the features and combinations of features mentioned hereinunder in the description of the figures and/or illustrated in the figures alone can be employed not only in the combination stated in each case but also in other combinations or on their own.

### BRIEF DESCRIPTION OF THE DRAWINGS

FIG. 1 shows a longitudinal sectional view of a charging system having an electric motor in accordance with the prior art which can be employed for use for a fuel cell,

FIG. 2 shows a longitudinal sectional view of a charging system of a fuel cell in a first exemplified embodiment,

FIG. 3 shows a longitudinal sectional view of the charging system of a fuel cell in a second exemplified embodiment,

FIG. 4 shows a longitudinal sectional detail of the charging system of a fuel cell according to FIG. 2,

FIG. 5 shows a longitudinal sectional detail of the charging system of a fuel cell in a third exemplified embodiment,

FIG. 6 shows a detailed view VI of the charging system according to FIG. 5,

FIG. 7 shows a longitudinal sectional detail of the charging system of a fuel cell in a fourth exemplified embodiment,

FIG. 8 shows a longitudinal sectional detail of the charging system of a fuel cell in a fifth exemplified embodiment,

FIG. 9 shows a longitudinal sectional view of the charging system of a fuel cell in a sixth exemplified embodiment,

FIG. 10 shows a longitudinal sectional view of the charging system of a fuel cell in a seventh exemplified embodiment,

FIG. 11 shows a longitudinal sectional view of the charging system of a fuel cell in an eighth exemplified embodiment, and

FIG. 12 shows a longitudinal sectional view of the charging system of a fuel cell in a ninth exemplified embodiment.

### DETAILED DESCRIPTION

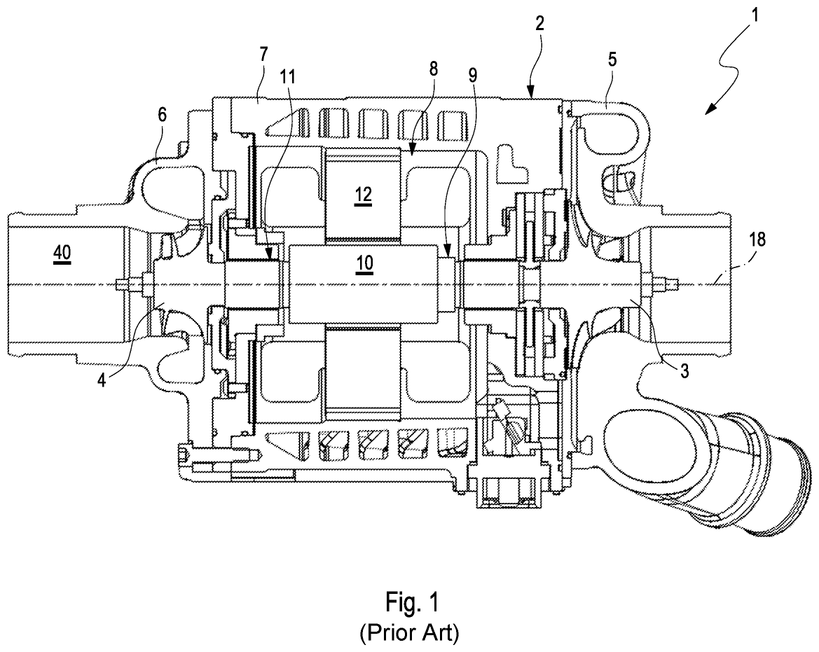

A charging system 1 in accordance with the prior art which is suitable for use for delivering air to a fuel cell is designed as shown in FIG. 1. The charging system 1 has a housing 2 for rotatably receiving a compression wheel 3 and an expansion wheel 4, wherein the housing 2 comprises a compression section 5 and an expansion section 6. The compression section 5 is designed to receive the compression wheel 3 and the expansion section 6 is designed to receive the expansion wheel 4. Arranged between the compression section 5 and the expansion section 6 is a motor housing 7 which is designed to receive an electric motor 8 and for rotatably mounting the compression wheel 3 and the expansion wheel 4. The electric motor 8 can be embedded or coated with the aid of sintering, fusing, casting or injection-moulding. Therefore, a solid closed structure of the electric motor 8 is formed which can be surrounded by a cooling medium.

The compression wheel 3 is connected with the aid of a compression wheel shaft 9 to a rotor 10 of the electric motor 8 which has a stator 12 surrounding the rotor 10. Likewise, the expansion wheel 4 is connected to the rotor 10 with the aid of an expansion wheel shaft 11. Expansion gas from the fuel cell can be applied to the expansion wheel 4 so that it performs a rotating movement which is transmitted via the rotor 10 to the compression wheel 3. Likewise, the rotor 10 is designed to produce and/or assist the rotating movement of the expansion wheel 4 and the compression wheel 5.

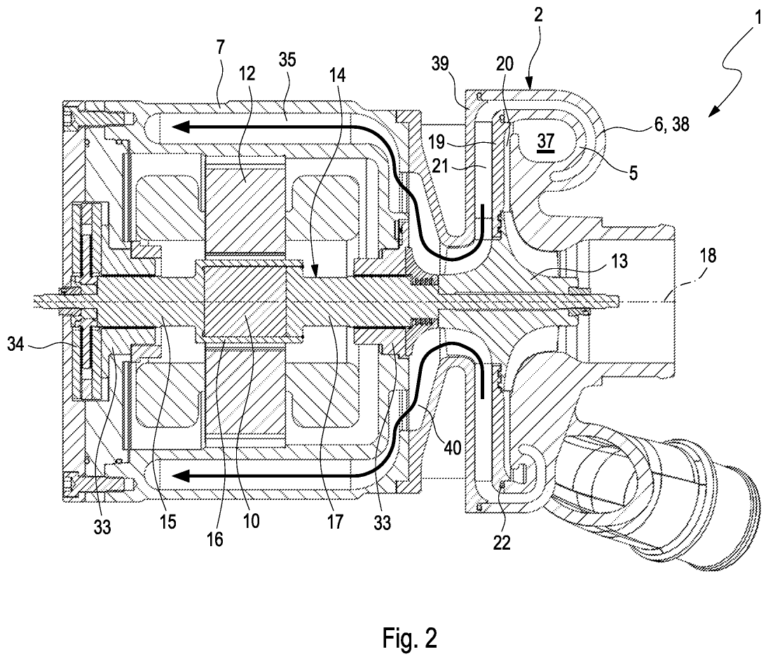

FIG. 2 illustrates an charging system 1 of a fuel cell according to a first exemplified embodiment. The charging system 1 is characterised by the fact that, in order to cool the electric motor 8 the motor housing 7 is formed with the housing 2 such that a flow can pass therethrough.

Furthermore, the charging system 1 for producing a compact and cost-effective design is characterised by a system wheel 13 which has the compression wheel 3 and the expansion wheel 4 formed as a single piece. The compression wheel 3 is produced from a first material which corresponds to a second material, from which the expansion wheel 4 is produced. Likewise, it could also be two different materials, wherein cost-effective production of the system wheel 13 can be achieved with the aid of a single material which is composed of different material components.

In the first exemplified embodiment according to FIG. 2, the expansion wheel 4 for delivering expansion gas, which flows through the expansion wheel 4, into the motor housing 7 is arranged in the housing 2. That is to say in other words that the expansion wheel 4 is arranged between the compression wheel 3 and the motor housing 7. Accordingly, the expansion section 6 is formed between the compression section 5 and the motor housing 7.

The compression section 5 and the expansion section 6 are designed to effect heat exchange of compression gases flowing in the compression section 5 and expansion gases flowing in the expansion section 6. It should be emphasised at this juncture that this is not gas exchange between the two sections 5, 6 but instead is a heat exchange of the gases via closed walls of the sections 5, 6, i.e. wall heat transfers.

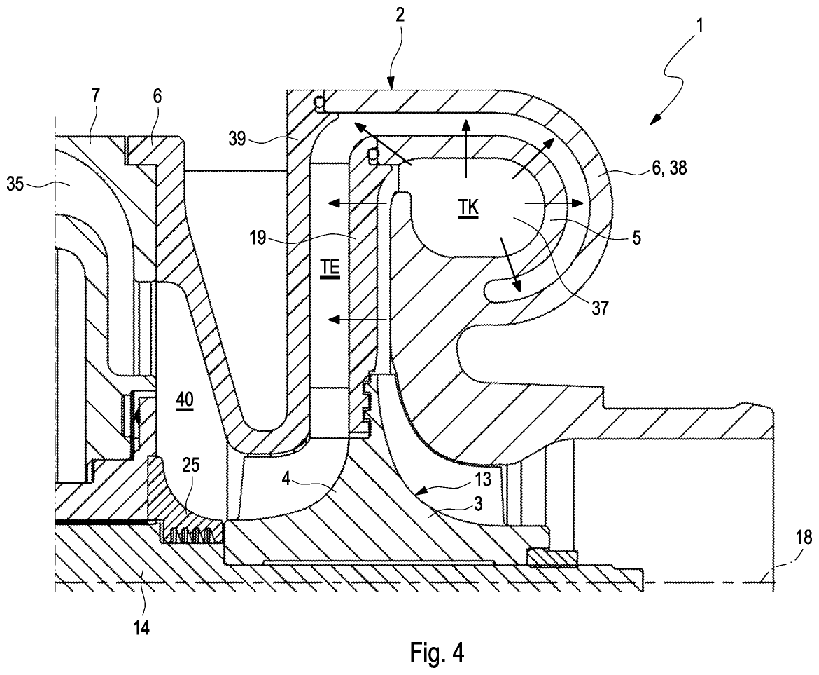

The expansion section 6 is designed at least partially surrounding the compression section 5, in particular in the region of a spiral 37 of the compression section 5. This is illustrated in a detailed manner in FIG. 4 in a longitudinal sectional detail of the charging system 1 according to the first exemplified embodiment. For improved mounting of the housing 2, the compression section 5 and a first expansion section part 38 designed surrounding the compression section 5 are produced as a single piece. The advantage can be seen in the fact that the compressed compression gas, which has a compression gas temperature TK having a value of over 200° C., heats the expansion gas, which has an expansion gas temperature TE of ca. 90° C., so that a thermodynamic gradient, which determines the performance of the charging system 1, can be increased at the expansion wheel 4 and vice versa because the colder expansion gas cools the warmer compression gas and air cooling of the compression gas can thus be omitted. Downstream of the expansion wheel 4, the expansion gas has an expansion gas temperature TE having a value of ca. 20° C. and can be used for cooling the motor housing 7, wherein the cooling jacket 35 is connected to the expansion section 6 such that a flow can pass therethrough. Therefore, it is possible to completely dispense with water cooling of the motor housing 7 because, in particular, extremely small water droplets absorb heat of the motor housing 7 and evaporate. The expansion gas which is channelled via the cooling jacket 35 is discharged to the environment via a housing outlet, not illustrated in greater detail. The bearings 33, 34 are designed in the form of air bearings.

A second expansion section part 39 which is arranged facing towards the motor housing 7 can be produced in one piece with the motor housing 7. Sealing means can thus be produced cost-effectively.

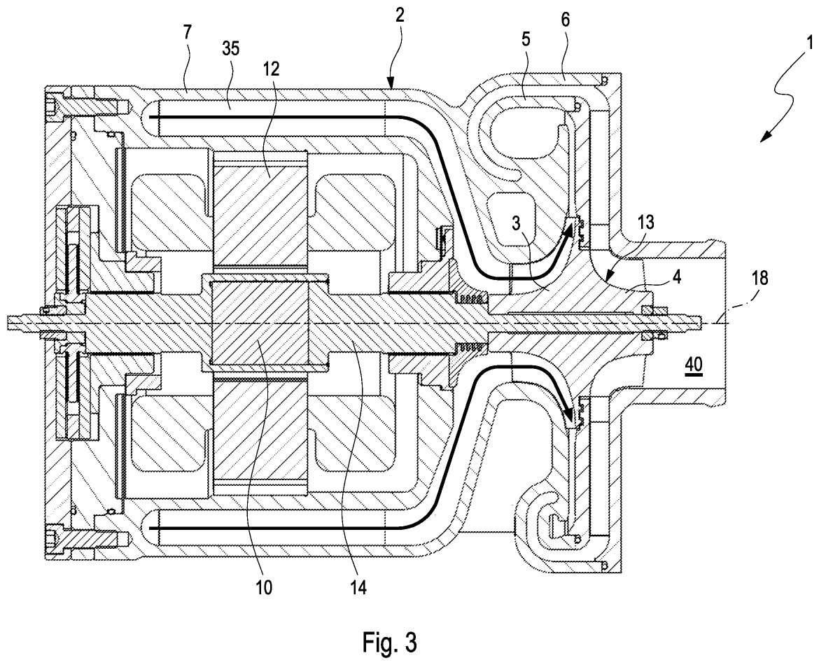

In FIG. 3 which illustrates the charging system 1 in a second exemplified embodiment, the motor housing 7 is likewise connected to the housing 2 such that a flow can pass therethrough. The substantial difference here, however, is that the compression wheel 3 and the compression section 5 are arranged between the expansion wheel 4 and the motor housing 7 or the expansion section 6 and the motor housing 7. In this case, the electric motor 8 is cooled by virtue of the fact that fresh air which is compressed in the compression section 5 is drawn in from the compression wheel 3 via the motor housing 7, thus producing an air flow which cools the cooling jacket 35.

The system wheel 13 can be driven with the aid of a built-up shaft 14. In this context, a built-up shaft 14 is to be understood to be in particular a two-part shaft which is designed to receive the rotor 10. The shaft 14 is rotatably mounted in the motor housing 7. The rotor 10 is connected to a first shaft section 15 in a non-twisting manner in a first shaft section 15 of the shaft 14, of which the end section 16 facing towards the system wheel 13 is hollow-cylindrical. A second shaft section 17 of the shaft 14 which is configured for conjoint rotation with the system wheel 13 is likewise received, at its shaft end arranged facing towards the first shaft section 15, in the end section 16 and is connected in an integrally bonded manner thereto. The illustrated embodiment of the built-up shaft 14 is merely one way of integrating the rotor 10 into the shaft 14. Other embodiments, e.g. in which the first shaft section 15 has the hollow-cylindrical end section and/or a force-fitting and form-fitting connection of the two shaft sections 15, 17 are likewise possible.

The housing 2 of the charging system 1 of the first exemplified embodiment has the compression section 5 and the expansion section 6 arranged completely next to one another in the axial direction along a longitudinal axis 18 of the charging system 1, wherein a common housing wall 19 fluidically separates from one another a compression channel 20 of the compression section 5 formed downstream of the compression wheel 3 and an expansion channel 21 of the expansion section 6 formed upstream of the expansion wheel 4. The housing wall 19 is arranged for producing a pressure-tight housing 2 between the compression section 5 and the expansion section 6 with the aid of sealing means 22.

In order to produce a compression section 5 which is substantially sealed with respect to the expansion section 6 and vice versa, a seal 23 is configured in the form of a labyrinth seal between these two sections 5, 6, wherein the labyrinth seal 23 is advantageously produced between the compression wheel 3 and a wall surface 24 of the housing wall 19 facing towards the compression wheel 3.

In order to prevent lubricant overflow from the motor housing 7 into the expansion section 6 and possibly into the compression section 5, and/or to prevent expansion gas overflow into the motor housing 7, a further sealing means 25, which is produced preferably in the form of a labyrinth seal, is arranged between the motor housing 7 and the expansion wheel 4, surrounding the second shaft section 17.

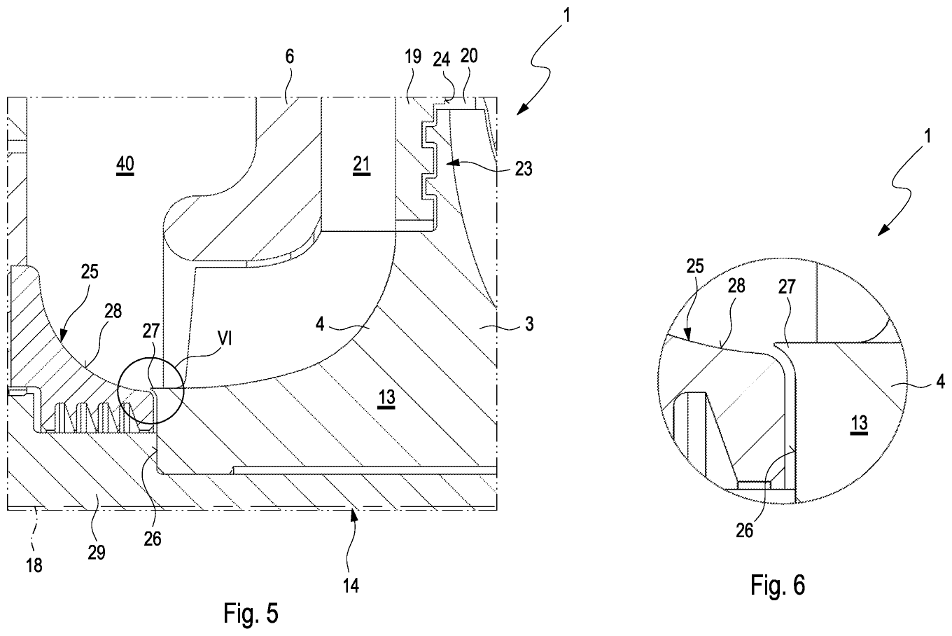

The reduction or preferably the prevention of lubricant overflow from the motor housing 7 into the expansion section 6 can be assisted with the aid of further exemplified embodiments, wherein, in particular, a seventh exemplified embodiment, as shown in FIGS. 5 and 6, wherein FIG. 6 is a detailed drawing VI taken from FIG. 5, is expedient in this respect, wherein a hub surface 26 of the system wheel 13 facing towards the further sealing means 25 is concavely curved relative to the further sealing means 25. In particular, the curvature in the form of one protruding partially over the further sealing means 25 in the axial direction is produced in the manner of a projection. That is to say in other words that the hub surface 26 has a projection 27 which is designed partially surrounding an outer surface 28 of the further sealing means 25. That is to say in other words that the system wheel 13 is liquid-repellent. Therefore, lubricant which is delivered via the further sealing means 25 in the direction of the system wheel 13 is delivered outwards in the radial direction with the aid of a centrifugal force of the system wheel 13 and is moved with the aid of the projection 27 in the direction of an outlet 40 of the expansion section 6. Likewise, liquid in the form of water present in the expansion section 6 can be delivered into the outlet 40, thus reducing the risk of ingress of the water into the motor housing 7.

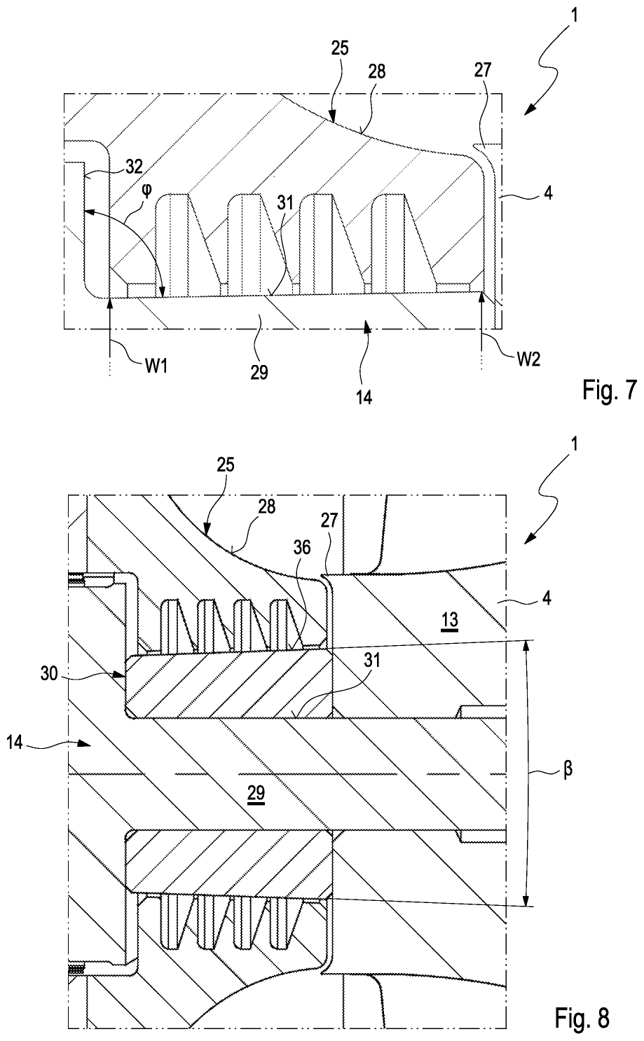

Further exemplified embodiments assisting the reduction or prevention of lubricant overflow are illustrated in FIGS. 7 and 8, wherein the exemplified embodiments can obviously be configured additively and not necessarily separately. In FIG. 7 which shows a longitudinal sectional detail of the charging system 1 in a fourth exemplified embodiment, an intermediate shaft section 29 which has the further sealing means 25 is produced in the form of a truncated cone, wherein a first shaft diameter W1 closest to the motor housing 7 is smaller than a second shaft diameter W2 facing towards the expansion wheel 4. Therefore, between a section periphery 31 of the intermediate shaft section 29 and a section wall 32 perpendicular to the longitudinal axis 18 there is formed an angle φ which has a value of less than 90°. That is to say in other words that the shaft diameter increases in the direction of the longitudinal axis 18 starting from the motor housing 7 in the direction of the expansion section 6. This can be continuous but can also be discontinuous.

FIG. 8 illustrates a longitudinal sectional detail of the charging system 1 in an fifth exemplified embodiment, wherein a sleeve 30 is configured surrounding the intermediate shaft section 29 and is produced in the form of a hollow truncated cone. This has the advantage that cost-effective production of the shaft 14 is achieved. In the longitudinal sectional view shown in FIG. 8 a sleeve periphery 36 has an opening angle β in the direction of the system wheel 13, of which the value is greater than 0°.

With the aid of the conical design of the shaft 14 and/or the sleeve 30 and/or the correspondingly designed hub surface 26, concavely and/or with projection 27, in particular the projection 27 attached to a largest surface diameter of the hub surface 26, it is possible to deliver liquids accumulated in the further sealing means 25 into the outlet 40 of the expansion section 6.

The charging system 1 according to the first exemplified embodiment has the shaft 14 mounted on air bearings. That is to say in other words that the shaft sections 15, 17 are rotatably mounted with the aid of a respective radial bearing 33 in the form of an air bearing, and the first shaft section 15 facing away from the system wheel 13 is also rotatably mounted with the aid of an axial bearing 34 in the form of an air bearing.

The bearings 33, 34 could also be designed in the form of plain bearings or rolling bearings, or could be characterised by a combination of the different bearing types. A combination is possible. It should be noted that in order to prevent ingress of hydrogen into the bearing 33; 34, which is designed in the form of a rolling bearing, an additional sealing means 40 is to be arranged at a side of the bearing 33; 34 arranged facing towards the system wheel 13. The cooling jacket 35 is designed for water cooling.

At this juncture, it should be mentioned that the sealing means 22, 25 can, of course, also be designed in the form of a lip seal.

In an exemplified embodiment which is not illustrated in greater detail, the motor housing 7 has, on its end facing away from the system wheel 13, an inverter which is configured to accommodate circuit boards. The form of the so-called “power electronic” can be circular or curved or triangular, it can have any possible shape.

In a further exemplified embodiment which is not illustrated in greater detail, the expansion channel 21 upstream of the expansion wheel 4 is equipped with a flow cross-section-changing device so that a flow cross-section formed upstream of the expansion wheel 4 can be varied. The flow cross-section-changing device can be designed e.g. in the form of an axial slide valve or in the form of rotatable guide vanes according to a known adjustable turbine geometry.

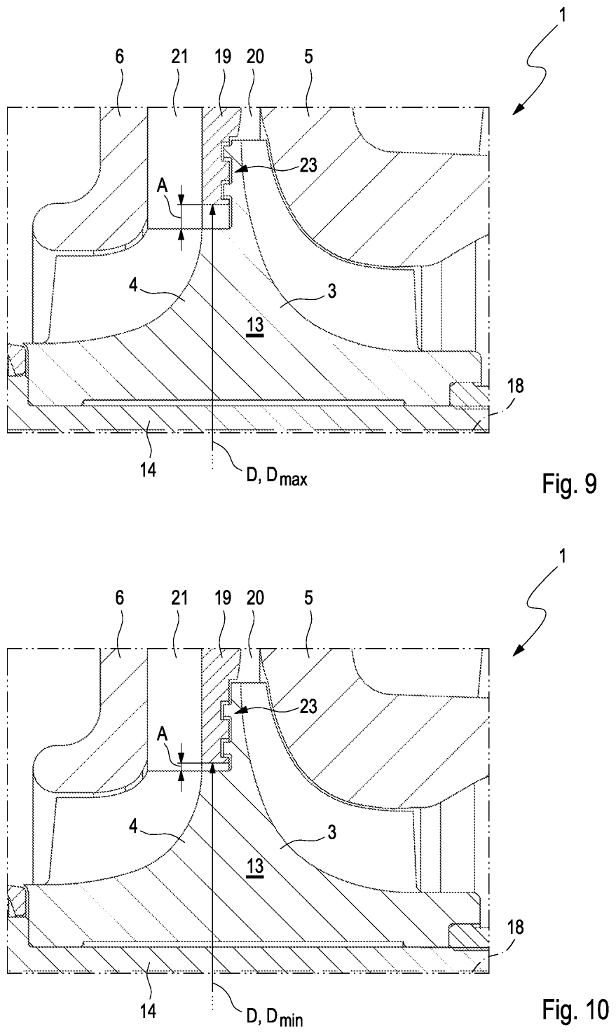

In a further exemplified embodiment of the charging system 1, a sixth exemplified embodiment according to FIG. 9 and a seventh exemplified embodiment according to FIG. 10, so-called trimming of the system wheel 13 is provided in order to adapt performance of the charging system 1, said trimming can be achieved with the aid of the housing wall 19, wherein, between the expansion wheel 4, which preferably has a smaller diameter than the compression wheel 3, and the housing wall 19 a distance A is to be designed to be variable by changing an inner housing wall diameter D. In so doing, diameter limit values, a smallest inner housing wall diameter Dₘᵢₙ and a largest inner housing wall diameter Dₘₐₓ are to be taken into account. With the aid of the inner housing diameter D, it is possible to effect adjustment of a thrust force which acts upon the two wheels, the expansion wheel 4 and the compression wheel 3.

In a further exemplified embodiment which is not illustrated in further detail, a pretensioning system is formed which is provided in order to axially pretension the rolling bearing arrangement, for receiving axial loads.

If the bearings are designed in the form of rolling bearings, they can have additional damping elements, e.g. in the form of a metallic elastic structure or in the form of a synthetic material which has damping properties and is arranged around the rolling bearing.

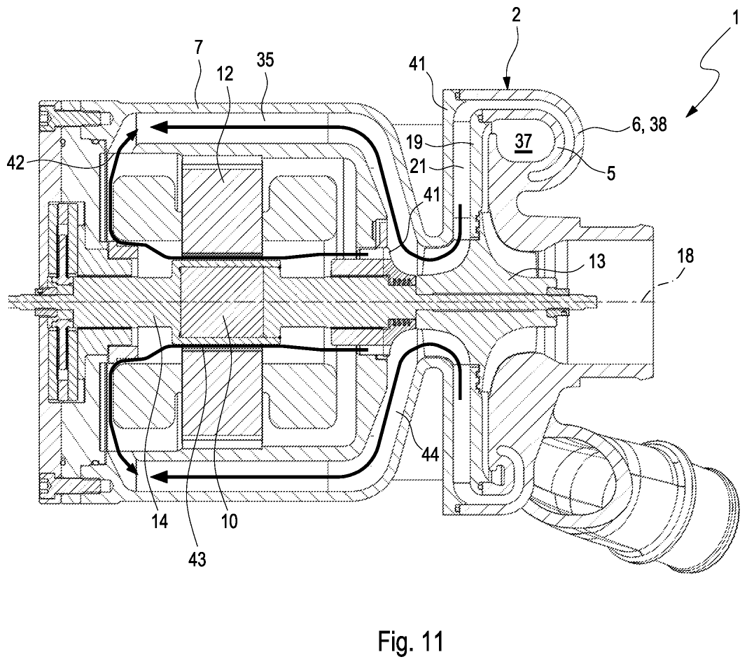

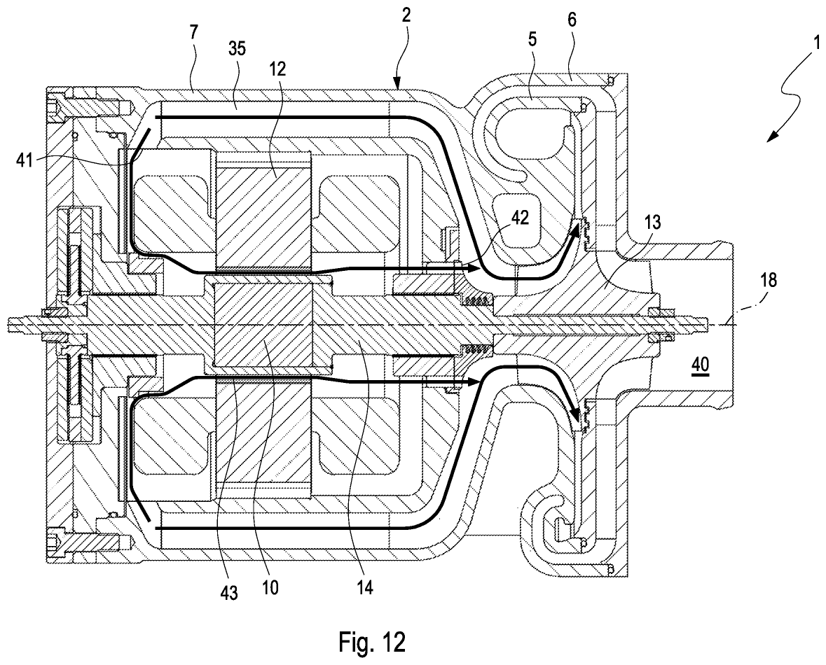

FIGS. 11 and 12 illustrate the charging system 1 of a fuel cell in an eighth and ninth exemplified embodiment respectively. The charging system 1 of the eighth exemplified embodiment as illustrated according to FIG. 11 corresponds to the greatest possible extent to the charging system 1 of the first exemplified embodiment, cf. FIG. 2, wherein, however, the motor housing 7 has a first housing opening 41 and a second housing opening 42 so that, in order to cool the stator 12 and the rotor 10, the expansion gas can flow from the first housing opening 41 into the second housing opening 42 via an air gap 43 formed between the rotor 10 and the stator 12. Therefore, additional cooling of the electric motor 8 is provided.

The charging system 1 of the ninth exemplified embodiment which is configured according to FIG. 12 corresponds to the greatest possible extent to the second exemplified embodiment of the charging system 1, which is illustrated in FIG. 3. The fresh air provided for additional cooling of the electric motor 8 flows from the first housing opening 41 into the second housing opening 42 via the air gap 43 and is supplied to the expansion section 6. In this case, the first housing opening 41 is provided in the region of an end of the housing 7 arranged facing away from the system wheel 13.

Preferably, in both cases for the purpose of directed flow through the air gap 43, the first housing opening 41 of the eighth exemplified embodiment or the second housing opening 42 of the ninth exemplified embodiment is arranged at the level of the air gap 43, or in other words at a radial distance from the longitudinal axis 18, which corresponds to a radial distance of the air gap 43 from the longitudinal axis 18.

In a further exemplified embodiment which is not illustrated in greater detail, the compression section 5 has an adjustable guide geometry. The guide geometry can be formed from an adjustable guide vane arrangement upstream of the compression wheel 3 and/or an adjustable nozzle vane arrangement downstream of the compression wheel 3 around the compression section 5. Likewise, in the case of a combination of the vane arrangements one of the two vane arrangements could be rigid.

With the aid of the adjustable guide vane arrangement in the form of a guide vane-pivotable about an axis—of the guide vane arrangement upstream of the compression wheel 3, an entrance angle of an air mass flow can be optimised for different rotational speeds. If the adjustable guide vane arrangement is designed in the form of an aperture, similar to an optical aperture, a mass flow can be easily adapted. If the adjustable nozzle vane arrangement is designed in the form of turnable guide vanes, an air mass flow exit angle exiting from the compression section 5 can be easily adapted.

The electric motor 8 can be designed differently. For instance, the stator 12 can be wound differently. For example, the winding can have grooves or no grooves and/or can have concentrated windings or distributed windings.

In a further exemplified embodiment which is not illustrated in greater detail, one of the wheels 3; 4, the compression wheel 3 or the expansion wheel 4, for receiving the shaft 14, can have an opening with an internal thread, or the shaft 14 is pressed into the opening.

In a further exemplified embodiment which is not illustrated in greater detail, a measuring device is provided for measuring a speed and/or an acceleration and/or a temperature and/or a pressure etc., wherein sensors of the measuring device are arranged preferably on the side of the electric motor 8 facing away from the wheels 3, 4.

In a further exemplified embodiment which is not illustrated in greater detail, a further compression wheel is provided which is arranged on the side of the electric motor 8 facing away from the wheels 3, 4.

### LIST OF REFERENCE SIGNS

1 charging system
2 housing
3 compression wheel
4 expansion wheel
5 compression section
6 expansion section
7 motor housing
8 electric motor
9 compression wheel shaft
10 rotor
11 expansion wheel shaft
12 stator
13 system wheel
14 shaft
15 first shaft section
16 end section
17 second shaft section
18 longitudinal axis
19 housing wall
20 compression channel
21 expansion channel
22 sealing means
23 seal
24 wall surface
25 further sealing means
26 hub surface
27 projection
28 outer surface
29 intermediate shaft section
30 sleeve
31 section periphery
32 section wall
33 radial bearing
34 axial bearing
35 cooling jacket
36 sleeve periphery
37 spiral
38 first expansion section part
39 second expansion section part
40 outlet
41 first housing opening
42 second housing opening
43 air gap
A distance
D inner housing wall diameter
Dₘᵢₙ smallest inner housing wall diameter
Dₘₐₓ. largest inner housing wall diameter
TE expansion gas temperature
TK compression gas temperature
W1 first shaft diameter
W2 second shaft diameter
φ angle
β opening angle

1.-20. (canceled)

21. A charging system (1) of a fuel cell, comprising
a housing (2) for receiving
a rotatable compression wheel (3) and
a rotatable expansion wheel (4),
wherein the housing (2) comprises
a compression section (5) and
an expansion section (6),
wherein the compression section (5) is designed to receive the compression wheel (3) and
wherein the expansion section (6) is designed to receive the expansion wheel (4); and
an electric motor (8) to drive a shaft (14) which is connected at least to the expansion wheel (4) for conjoint rotation therewith,
wherein the electric motor (8) is accommodated in a motor housing (7),
wherein, in order to cool the electric motor (8), the motor housing (7) is formed with the housing (2) such that a flow can pass therethrough,
wherein the expansion wheel (4) for delivering expansion gas, which flows through the expansion wheel (4), into the motor housing (7) is arranged in the housing (2), and
wherein the expansion wheel (4) is arranged between the compression wheel (3) and the motor housing (7).

22. The charging system (1) as claimed in claim 21,
wherein the compression wheel (3) for drawing in air via the motor housing (7) is arranged in the housing (2).

23. The charging system as claimed in claim 21,
wherein the compression wheel (3) and the expansion wheel (4) are designed in the form of a single-piece system wheel (13) which has the shaft (14).

24. The charging system (1) as claimed in claim 21,
wherein the compression section (5) and the expansion section (6) are designed to effect wall heat exchange of compression gases flowing in the compression section (5) and expansion gases flowing in the expansion section (6).

25. The charging system (1) as claimed in claim 21,
wherein the expansion section (6) is designed at least partially surrounding the compression section (5).

26. The charging system (1) as claimed in claim 21,
wherein the expansion section (6) is arranged at least partially axially next to the compression section (5).

27. The charging system (1) as claimed in claim 21,
wherein the motor housing (7) is designed to mount the shaft (14).

28. The charging system (1) as claimed in claim 21,
wherein the motor housing (7) is designed at least partially as a single piece with the housing (2).

29. The charging system (1) as claimed in claim 21,
wherein the shaft (14) is a built-up shaft.

30. The charging system (1) as claimed in claim 29,
wherein the shaft (14) is designed to receive a rotor (10) of the electric motor (8).

31. The charging system (1) as claimed in claim 21,
wherein a housing wall (19) which separates the compression section (5) and the expansion section (6) has a seal (23) in the form of a labyrinth seal.

32. The charging system (1) as claimed in claim 31,
wherein the labyrinth seal is formed between the compression wheel (3) and the housing wall (19).

33. The charging system (1) as claimed in claim 21,
wherein the shaft (14) has a radial bearing (33) which is a plain bearing or a rolling bearing or an air bearing.

34. The charging system (1) as claimed in claim 21,
wherein the shaft (14) has an axial bearing (34) which is a plain bearing or a rolling bearing or an air bearing.

35. The charging system (1) as claimed in claim 21,
wherein a further sealing means (25) is arranged on a conical section of the shaft (14) and/or on a conical sleeve (30) surrounding the shaft (14).

36. The charging system as claimed in claim 35,
wherein the further sealing means (25) is designed in the form of a labyrinth seal.

37. The charging system (1) as claimed in claim 23,
wherein the system wheel (13) is liquid-repellent and/or liquid-resistant.

38. The charging system (1) as claimed in claim 37,
wherein a hub surface (26) of the system wheel (13) facing the electric motor (8) is liquid-repellent and/or liquid-resistant.

39. The charging system (1) as claimed in claim 38,
wherein the hub surface (26) has a projection (27).

40. The charging system (1) as claimed in claim 21,
wherein a flow cross-section-changing device is formed upstream of the expansion wheel (4) in the expansion section (6).
